(19) United States
(12) Patent Application Publication
(10) Pub. No.: US 2026/0257525 A1
(43) Pub. Date: Sep. 3, 2026

(54) SHOCK ABSORBER

(71) Applicant: KYB Corporation, Tokyo (JP)

(72) Inventor: Kazuma ANDO, Tokyo (JP)

(73) Assignee: KYB Corporation, Tokyo (JP)

(21) Appl. No.: 18/719,002

(22) PCT Filed: Jan. 13, 2023
(86) PCT No.: PCT/JP2023/000740

§ 371 Date: Jun. 12, 2024

(30) Foreign Application Priority Data
Mar. 23, 2022 (JP) 2022-046220

(51) Int. Cl. B60G 13/00

(52) U.S. Cl. CPC B60G 13/005; B60G 2200/142; B60G 2204/4304; B60G 2204/4308; B60G 2206/41

(57) ABSTRACT

There is provided: a protruding portion that is provided on a side portion of an outer shell of a shock absorber main body, which is interposed between a vehicle body and a wheel in a vehicle, and protrudes radially outward; and a bracket that is attached to an outer circumference of the outer shell, in which an insertion hole through which the protruding portion is inserted is formed in one side portion of a cylindrical portion of the bracket, and the cylindrical portion has a protection wall that rises along an edge of the insertion hole located closer to one of the attachment portions than an axis of the outer shell when viewed at least from the one side portion side of the cylindrical portion or a protection wall that rises from an entire edge of the insertion hole located closer to one of the attachment portions than a plane passing through at least an axis of the cylindrical portion and an axis of the protruding portion.

### TECHNICAL FIELD

The present invention relates to a shock absorber.

### BACKGROUND ART

Heretofore, for example, as disclosed in JP 2015-59574 A, some shock absorbers have a damping force variable valve attached to a side portion of an outer shell. In the shock absorber, the magnitude of a damping force generated by the shock absorber can be adjusted by causing the damping force variable valve to adjust resistance applied to a flow of operating fluid generated when the shock absorber extends and contracts. Further, when the damping force variable valve is provided on the side portion of the outer shell so as to protrude radially outward, the axial length of the shock absorber can be shortened without sacrificing the stroke length of the shock absorber. Thus, such a shock absorber can achieve better ease of mounting.

In addition, for example, as disclosed in JP 2018-25224 A, some shock absorbers are used for a strut type suspension, and used as a support for positioning a wheel in such a way as to be connected to a knuckle that holds a wheel via a bracket fixed by welding to an outer circumference of a lower end portion of an outer shell. When the shock absorber having the bracket includes a protruding portion such as the above-described damping force variable valve, the protruding portion is sometimes disposed in a portion covered by the bracket. In this case, a hole allowing insertion of the protruding portion is provided in the bracket, and the protruding portion is welded to the side portion of the outer shell exposed by the hole.

### CITATION LIST

### Patent Literature

Patent Literature 1: JP 2015-59574 A

Patent Literature 2: JP 2018-25224 A

### SUMMARY OF INVENTION

### Technical Problem

In the conventional shock absorbers, a welded portion of the protruding portion is completely exposed from the hole of the bracket, so that adhesion of a coating film in the welded portion is poor. For this reason, in a case where the shock absorber is mounted on a vehicle, there is a risk that a stone chip or the like flying from a road surface hits the welded portion of the protruding portion during traveling of the vehicle, and this causes the coating film of the welded portion to be peeled off. When the coating film is peeled off, the welded portion is exposed to the outside, which causes rust.

Against this background, an object of the present invention is to provide a shock absorber that prevents a coating film of a welded portion of a protruding portion from being peeled off, and prevents the welded portion from being rusted.

### Solution to Problem

In order to achieve the above object, in a shock absorber according to the present invention, a bracket that is attached to an outer circumference of an outer shell has a cylindrical portion that has a C-shaped cross section with a split in a front portion while holding the outer circumference of the outer shell and a pair of attachment portions that protrudes radially outward from both ends in a circumferential direction of the cylindrical portion and is capable of being attached to a knuckle supporting a wheel, the cylindrical portion has an insertion hole that is located in one side portion of the cylindrical portion and through which a protruding portion provided on a side portion of the outer shell is inserted, and the cylindrical portion has a protection wall that rises from an entire edge of the insertion hole located closer to one of the attachment portions than an axis of the outer shell when viewed at least from the one side portion side of the cylindrical portion. According to this configuration, at least the wheel side of the welded portion of the protruding portion to which a stone chip or the like is most likely to fly is surrounded by the protection wall and protected from a stone chip or the like.

In order to achieve the above object, in another shock absorber according to the present invention, a bracket that is attached to an outer circumference of an outer shell has a cylindrical portion that has a C-shaped cross section with a split in a front portion while holding the outer circumference of the outer shell and a pair of attachment portions that protrudes radially outward from both ends in a circumferential direction of the cylindrical portion and is capable of being attached to a knuckle supporting a wheel, the cylindrical portion has an insertion hole that is located in one side portion of the cylindrical portion and through which a protruding portion provided on a side portion of the outer shell is inserted, and the cylindrical portion has a protection wall that rises from an entire edge of the insertion hole located closer to one of the attachment portions than a plane passing through at least an axis of the cylindrical portion and an axis of the protruding portion. According to this configuration, at least the wheel side of the welded portion of the protruding portion to which a stone chip or the like is most likely to fly is surrounded by the protection wall and protected from a stone chip or the like.

### BRIEF DESCRIPTION OF DRAWINGS

FIG. 1 is an installation view illustrating how a shock absorber according to an embodiment of the present invention is installed.

FIG. 2 is a longitudinal sectional view illustrating a simplified longitudinal section of a shock absorber main body of the shock absorber according to the embodiment of the present invention.

FIG. 3 is an enlarged side view of a bracket portion of the shock absorber according to the embodiment of the present invention.

FIG. 4 is a front view illustrating a bracket of the shock absorber according to the embodiment of the present invention.

FIG. 5 is a plan view illustrating the bracket of the shock absorber according to the embodiment of the present invention.

FIG. 6 is a front view illustrating an insertion hole observed when the bracket of the shock absorber according to the embodiment of the present invention is developed,

FIG. 7 is an enlarged perspective view of the bracket portion of the shock absorber according to the embodiment of the present invention.

FIG. 8(a) is an explanatory view illustrating the shock absorber in a state where a protruding portion is welded to an outer shell. FIG. 8(b) is a view illustrating the shock absorber in a state where the bracket is welded to the outer shell. In each of the explanatory views, the bracket is illustrated in a simplified manner.

FIG. 9 is an enlarged perspective view of a bracket portion of a shock absorber according to a modification of the embodiment of the present invention.

### DESCRIPTION OF EMBODIMENTS

An embodiment of the present invention will be described below with reference to the drawings. The same reference signs throughout the several drawings indicate the same part.

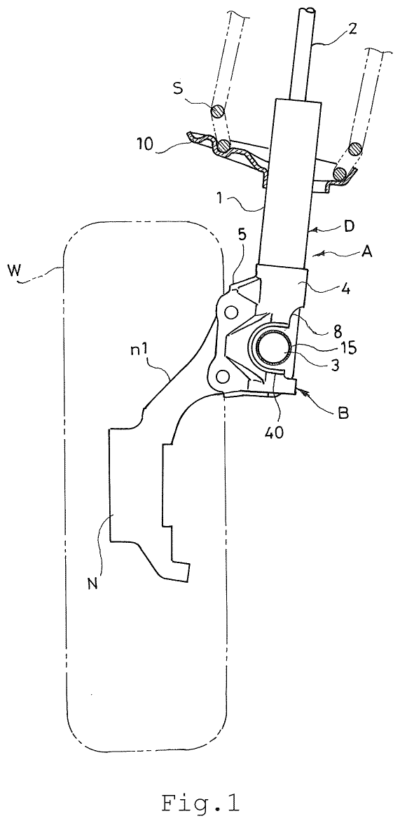

As illustrated in FIG. 1, a shock absorber A according to the embodiment of the present invention is used for a strut type suspension, and is used for a vehicle such as a four-wheeled automobile. The shock absorber A includes: a shock absorber main body D that has a cylindrical outer shell 1 and a rod 2 inserted into the outer shell 1; a vehicle body side mount (not illustrated) that couples the rod 2 to a vehicle body; a bracket B that couples the outer shell 1 to a wheel W; an upper spring seat (not illustrated) that is attached to the vehicle body side mount; a dish-shaped lower spring seat 10 that is attached to an outer circumference of the outer shell 1; and a suspension spring S that is interposed between both spring seats. Thus, the shock absorber main body D is interposed between the vehicle body and the wheel W in the vehicle.

More specifically, the wheel W is rotatably supported by a knuckle N, the bracket B is fixed by a bolt to a knuckle arm n1 that is provided in the knuckle N and extends obliquely upward in FIG. 1, and the shock absorber main body D functions as a support for positioning the wheel W. When the wheel W moves up and down with respect to the vehicle body as the vehicle travels on a bumpy road surface, for example, the rod 2 moves in and out of the outer shell 1 and the shock absorber main body D extends and contracts, and the upper spring seat moves closer and further away and the suspension spring S extends and contracts, whereby the shock absorber A extends and contracts.

The suspension spring S is a coil spring and is provided on the outer circumference of the shock absorber main body D. When compressed, the suspension spring S exerts a resilient force, and this resilient force increases as the amount of compression on the suspension spring S increases. The vehicle body is elastically supported by this suspension spring S. Note that, the configuration of the suspension spring S can be changed as appropriate. For example, the suspension spring S may be a spring other than a coil spring such as an air spring.

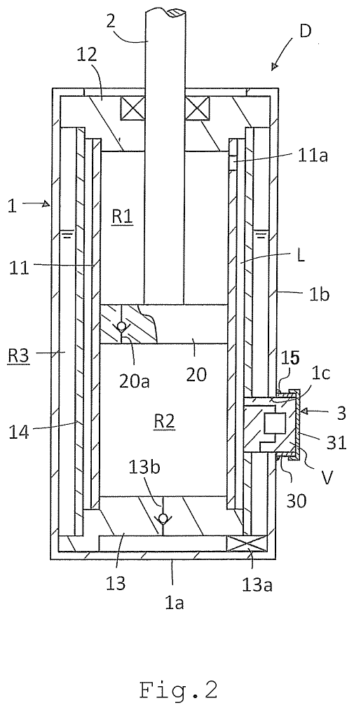

As described above, the shock absorber main body D includes the outer shell 1 and the rod 2, and in addition, as illustrated in FIG. 2, includes: a cylinder 11; a piston 20 that is slidably inserted into the cylinder 11; an annular rod guide 12 that is fixed to an upper end portion of the cylinder 11; a bottom member 13 that is fixed to a lower end portion of the cylinder 11; and an intermediate cylinder 14 that is provided to the outer circumference of the cylinder 11. The cylinder 11 and the intermediate cylinder 14 are arranged inside the outer shell 1, and the cylinder 11, the intermediate cylinder 14, and the outer shell 1 constitute a triple tube. The lower end of the rod 2 in FIG. 2 is coupled to the piston 20, and the upper side thereof protrudes to the outside of the outer shell 1 while being supported by the rod guide 12.

As illustrated in FIG. 2, the outer shell 1 has a bottomed cylindrical shape, and includes a bottom cap la that serves as a bottom portion and a cylindrical portion 1b that extends upward from an outer circumferential portion of the bottom cap la. Further, an upper end opening edge of the cylindrical portion 1b is closed by the rod guide 12 to seal a space formed inside the outer shell 1. Besides, an attachment hole 1c penetrating the thickness of the cylindrical portion 1b is formed in a side portion of the outer shell 1. A damping force variable valve V to be described later is attached to the attachment hole 1c in a state where a distal end thereof is inserted.

The inside of the cylinder 11 is partitioned into two chambers of an extension side chamber R1 and a compression side chamber R2 by the piston 20, and each chamber is filled with a liquid such as hydraulic oil. The chamber formed on the rod 2 side of the piston 20 is the extension side chamber R1, the chamber formed on the opposite side is the compression side chamber R2, and the rod 2 penetrates a central portion of the extension side chamber R1. The piston 20 is provided with a piston passage 20a that allows only a flow of liquid from the compression side chamber R2 to the extension side chamber R1.

Meanwhile, on the outer circumference of the cylinder 11, a cylindrical discharge passage L is formed between the cylinder 11 and the intermediate cylinder 14, and a cylindrical liquid storage chamber R3 is formed between the intermediate cylinder 14 and the outer shell 1. The liquid storage chamber R3 is filled with the above liquid and gas. In the cylinder 11, a through hole 11a is formed at a position facing the extension side chamber R1, and the discharge passage L allows the extension side chamber R1 and the liquid storage chamber R3 to communicate with each other via the through hole 11a. The damping force variable valve V is provided in the discharge passage L, and the damping force variable valve V can apply resistance to the flow of liquid in the discharge passage L and adjust the resistance.

In addition, the bottom member 13 has a notch 13a for guiding the liquid in the liquid storage chamber R3 into between the bottom member 13 and the bottom cap 1a and a suction passage 13b that allows only the flow of liquid from the liquid storage chamber R3 toward the compression side chamber R2.

According to the above configuration, when the rod 2 retracts from the outer shell 1 and the shock absorber A extends, the piston 20 moves upward in FIG. 2 in the cylinder 11, the extension side chamber R1 contracts, and the compression side chamber R2 expands. Liquid in the extension side chamber R1 that contracts when the shock absorber A extends flows out to the liquid storage chamber R3 through the through hole 11a and the discharge passage L. Since resistance is applied to the flow of the liquid by the damping force variable valve V, the pressure in the extension side chamber R1 increases when the shock absorber A extends, which suppresses an extension operation of the shock absorber A. In this manner, the shock absorber A exerts an extension side damping force that suppresses an extension operation. In addition, the liquid in the liquid storage chamber R3 is supplied to the expanded compression side chamber R2 through the notch 13a and the suction passage 13b.

In contrast, when the rod 2 enters the outer shell 1 and the shock absorber A contracts, the piston 20 moves downward in FIG. 2 in the cylinder 11, the compression side chamber R2 contracts, and the extension side chamber R1 expands. Liquid in the compression side chamber R2 that contracts when the shock absorber A contracts moves to the extension side chamber R1 that expands through the piston passage 20a. Further, at the time of contraction of the shock absorber A, since liquid corresponding to the volume of the rod 2 entering the cylinder 11 becomes surplus in the cylinder 11, the surplus liquid flows out to the liquid storage chamber R3 through the through hole 11a and the discharge passage L. Since resistance is applied to the flow of the liquid by the damping force variable valve V, the pressure in the cylinder 11 increases when the shock absorber A contracts, which suppresses a contraction operation of the shock absorber A. In this manner, the shock absorber A exerts a compression side damping force that suppresses a contraction operation.

In other words, in the shock absorber A, the intermediate cylinder 14 and the outer shell 1 constitute a reservoir in which the liquid storage chamber R3 is formed, and the reservoir can compensate for a volume change in the cylinder corresponding to the volume of the rod that enters and exits the cylinder 11 and can compensate for a volume change of liquid due to a temperature change.

Further, the shock absorber A is set to a uniflow type, and when the shock absorber A extends and contracts, liquid circulates in three chambers of the extension side chamber R1, the liquid storage chamber R3 (reservoir), and the compression side chamber R2 in this order in a one-way manner, and the liquid always flows through the discharge passage L from the extension side chamber R1 toward the liquid storage chamber R3 (reservoir). Thus, the single damping force variable valve V provided partway in the discharge passage L can exert the damping force on both sides of the extension side and the compression side, and the resistance applied to the flow of the liquid can be adjusted to adjust the damping force on both sides of the extension side and the compression side.

The damping force variable valve V may have any configuration. For example, the damping force variable valve V includes a valve seat member in which a passage connected to the discharge passage L is formed, a main valve that is separated from and seated on the valve seat member to open and close the passage, a pilot passage that reduces the pressure on the upstream side of the main valve to guide the pressure to a back surface of the main valve, and a pilot valve that is provided partway in the pilot passage to control the back pressure of the main valve. Then, in a case where the pilot valve is a solenoid valve, when the valve opening pressure of the pilot valve is increased or decreased by adjusting the amount of current to be applied to the pilot valve, the magnitude of the damping force can be adjusted by increasing or decreasing the valve opening pressure of the main valve.

In addition, the damping force variable valve V is accommodated in a case, and the case includes a cylindrical sleeve 30 that is welded to an edge portion of an attachment hole 1c formed in a side portion of the outer shell 1 and a cap 31 that closes an opening of the sleeve 30. Thus, when the damping force variable valve V is accommodated in the sleeve 30 after the sleeve 30 is welded to the outer shell 1, the damping force variable valve V can be fixed to the side portion of the outer shell 1 while protruding radially outward. As described above, in the shock absorber A, the case portion accommodating the damping force variable valve V constitutes a protruding portion 3 that protrudes radially outward on the side portion of the outer shell 1. As illustrated in FIG. 1, an insertion hole 8 for avoiding interference with the protruding portion 3 is formed in the bracket B for coupling the outer shell 1 to the knuckle N to which the outer shell is attached. Note that, in the present embodiment, the protruding portion 3 protrudes perpendicularly to the axial direction of the outer shell 1, but may protrude while being inclined with respect to the axial direction of the outer shell 1.

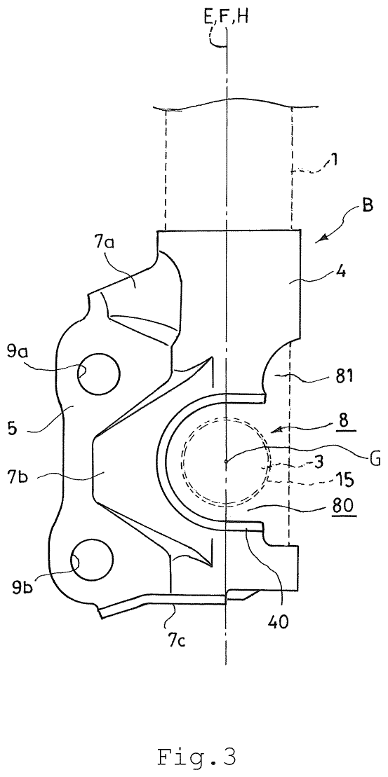

Hereinafter, the bracket B of the present embodiment will be described in detail. As illustrated in FIGS. 3 to 5, the bracket B includes: a cylindrical portion 4 that is curved so as to follow the outer circumferential surface of the outer shell 1 and has a C-shaped cross section covering the outer circumference of the outer shell 1; a pair of plate-like attachment portions 5 and 6 that extends radially outward from both circumferential ends of the cylindrical portion 4; and reinforcement ribs 7a, 7b, and 7c. As illustrated in FIGS. 3, 4, and 6, the insertion hole 8 formed in the cylindrical portion 4 is formed from one side portion to the back portion of the cylindrical portion 4.

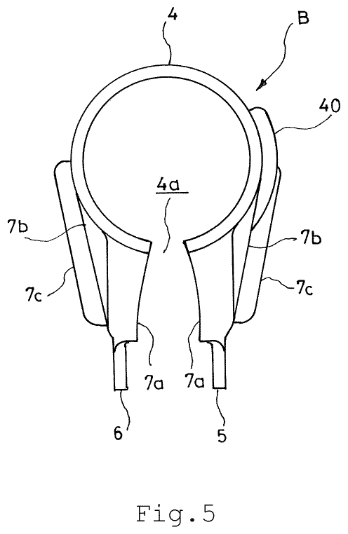

In the following description, as illustrated in FIG. 5, when the bracket B is viewed in the axial direction, a portion on a side where the pair of attachment portions 5 and 6 is provided in a circumferential direction is referred to as a front portion of the bracket B and the cylindrical portion 4, a portion on the opposite side of the front portion is referred to as a back portion, and a left side portion and a right side portion in the drawing are referred to as left and right side portions.

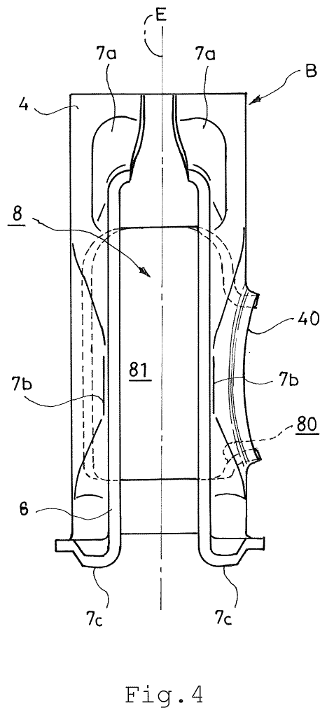

Hereinafter, for convenience of description, the upper, lower, left, right, front, and back of the bracket B illustrated in FIG. 4 are simply referred to as “upper”, “lower”, “left”, “right”, “front”, and “back” unless otherwise specified.

A split 4a is formed in the front portion of the cylindrical portion 4 along the axial direction, and a cross section obtained by cutting the cylindrical portion 4 in its radial direction has a C-shape throughout the axial direction. The left and right attachment portions 5 and 6 extend toward the front from both ends in the circumferential direction of the cylindrical portion 4 while maintaining a constant interval, and are arranged to face each other. All of the ribs 7a, 7b, and 7c are each provided to extend from the cylindrical portion 4 to the attachment portions 5 and 6, and are formed at the upper portion, the central portion in the axial direction (up and down), and the lower end of the bracket B, respectively. Note that, the positions and shapes of the ribs 7a, 7b, and 7c are not limited to those illustrated in the drawing, and may be any positions and shapes as long as the rigidity of the bracket B can be secured.

In addition, as illustrated in FIG. 3, holes 9a and 9b through which bolts can be inserted are formed in upper and lower portions of each of the left and right attachment portions 5 and 6, respectively. Then, as illustrated in FIG. 1, the knuckle arm n1 is inserted into between the pair of attachment portions 5 and 6, a bolt is inserted from the hole 9a on the upper side of the one attachment portion 6 to the hole 9a on the upper side of the other attachment portion 5, a bolt is inserted from the hole 9b on the lower side of the one attachment portion 6 to the hole 9b on the lower side of the other attachment portion 5, and nuts are screwed to the upper and lower bolts to tighten these nuts, whereby the bracket B is coupled to the knuckle N.

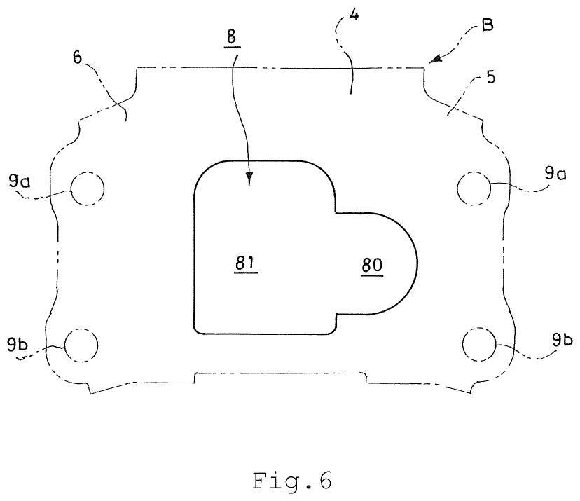

Subsequently, as described above, the insertion hole 8 is formed in the cylindrical portion 4 from one side portion which is the right side of the cylindrical portion 4 to the back portion as illustrated in FIGS. 3 and 6. In the insertion hole 8, a portion formed in one side portion of the cylindrical portion 4 is referred to as a side opening 80, and a portion formed in the back portion of the cylindrical portion 4 is referred to as a back opening 81.

As illustrated in FIG. 3, the side opening 80 prevents interference between the bracket B and the protruding portion 3 while allowing the protruding portion 3 to protrude outward from the side portion of the cylindrical portion 4 in a state where the bracket B is welded to the outer circumference of the outer shell 1. In addition, the edge of the side opening 80 is curved in a circular arc shape so as to bulge toward the front portion. Thus, it is easy to secure the rigidity of the bracket B while avoiding interference between the edge of the insertion hole 8 and the protruding portion 3 in a state where the protruding portion 3 protrudes from the side portion of the cylindrical portion 4. Further, as will be described in detail later, the cylindrical portion 4 has a protection wall 40 rising from the edge of the side opening 80 as illustrated in FIG. 3.

The back opening 81 prevents interference between the bracket B and the protruding portion 3 while allowing the protruding portion 3 to protrude outward from the back portion of the cylindrical portion 4 in a state where the outer shell 1 is inserted into the cylindrical portion 4. Further, as illustrated in FIG. 6 illustrating the shape of the insertion hole 8 in a state where the bracket B is deployed, the axial length of the back opening 81 is longer than the axial length of the side opening 80, and the upper edge of the back opening 81 is curved so as to bulge upward. Thus, it is easy to secure the rigidity of the bracket B while securing a long distance from the protruding portion 3 to the edge of the insertion hole 8 in a state where the protruding portion 3 protrudes from the back portion of the cylindrical portion 4. As illustrated in FIG. 6, the side opening 80 is connected to a lower side of the back opening 81.

However, the shape of the insertion hole 8 described above is an example, and is not limited to the shape described above. For example, the side opening 80 may be connected to an upper side of the back opening 81. Further, the back opening 81 may be omitted if unnecessary.

In addition, the insertion hole 8 may be formed from the left and right side portions of the cylindrical portion 4 to the back portion thereof. In this case, side openings are formed in the left and right side portions of the cylindrical portion 4, respectively, and a back opening having a longer axial length than the left and right side openings is formed in the back portion of the cylindrical portion 4, so that the bracket B has a line-symmetrical shape symmetrical with respect to the axis E of the cylindrical portion 4.

As described above, when the bracket B has a line-symmetrical shape with respect to the axis E of the cylindrical portion 4, the protruding portion 3 can protrude from either the left or right side opening when the shock absorber A is used in the vehicle, so that the common bracket B can be used for both the shock absorber A attached to the left wheel W and the shock absorber A attached to the right wheel W. Accordingly, it is possible to reduce the number of types of components constituting the vehicle, and it is also possible to prevent erroneous assembling of the bracket B, such as mounting the right bracket B on the left shock absorber A.

In addition, the bracket B of the present embodiment is formed by bending a base material which is one metal plate. Thus, when the bracket B has a line-symmetrical shape with respect to the axis E of the cylindrical portion 4, the difference in rigidity between the right and left sides of the bracket B is reduced when the bracket B is formed by bending, so that the bracket B can be easily formed. Note that, the bracket B of the present embodiment has a single-plate structure made of a single metal plate, but may have a double-plate structure including an inner bracket having a U-shaped cross section and inserted into between the pair of attachment portions 5 and 6.

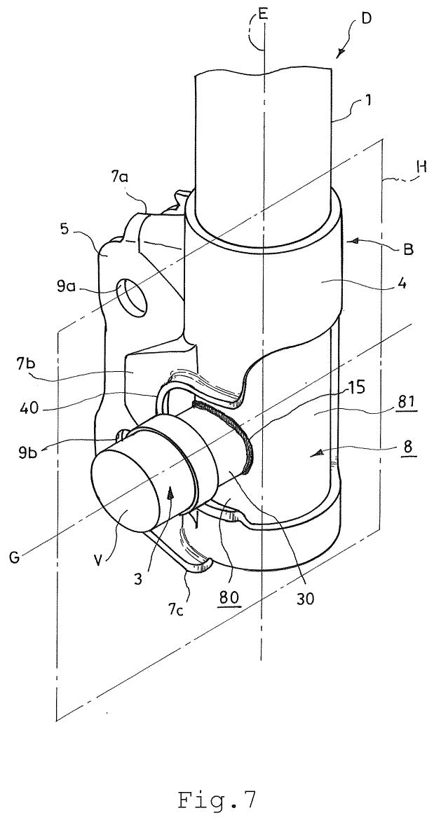

Returning to this, as illustrated in FIG. 3, the protection wall 40 of the present embodiment rises from the edge of the side opening 80 in the insertion hole 8. Note that, as illustrated in FIG. 7, the protection wall 40 rises while being inclined from the edge of the side opening 80 toward the inside which is the center side of the side opening 80, but may rise vertically from the edge of the side opening 80, or may rise while being inclined outward from the edge of the side opening 80.

As described above, when the protection wall 40 rising from the edge of the side opening 80 is provided, as illustrated in FIGS. 3 and 7, in a state where the protruding portion 3 is disposed in the side opening 80 of the insertion hole 8, one attachment portion 5 side, which is the left side in FIG. 3 and located above and below a welded portion 15 of the protruding portion 3 and in front of the welded portion is surrounded by the protection wall 40 protruding from the edge of the side opening 80 toward the outside of the cylindrical portion 4.

Here, as illustrated in FIG. 1, since the attachment portions 5 and 6 are attached to the knuckle N that supports the wheel W, the wheel W is disposed on the attachment portions 5 and 6 side of the bracket B. Thus, when the upper and lower sides of the welded portion 15 of the protruding portion 3 and the one attachment portion 5 side are surrounded by the protection wall 40 as described above, the protection wall 40 serves as a shield to protect the welded portion 15 from a stone chip or the like flying from the upper and lower directions of the vehicle and the wheel W side. Thus, it is possible to prevent a coating film of the welded portion 15 of the protruding portion 3 from being peeled off by hitting of a stone chip or the like, and the welded portion 15 from being rusted. Further, since the protection wall 40 also functions as a reinforcing rib, the rigidity of the bracket B is improved.

In addition, in the present embodiment, the protection wall 40 rises from the entire circumferential edge of the side opening 80, but as illustrated in FIG. 3, the protection wall 40 only needs to rise from the entire edge of the insertion hole 8 located closer to the one attachment portion 5 than an axis F of the outer shell 1 when viewed at least from one side portion side of the cylindrical portion 4. In this way, at least the wheel W side of the welded portion 15 of the protruding portion 3 to which a stone chip or the like is most likely to fly can be surrounded by the protection wall 40.

Alternatively, as illustrated in FIGS. 3 and 7, the protection wall 40 only needs to rise from at least the entire edge of the insertion hole 8 located closer to the one attachment portion 5 than a plane H passing through the axis E of the cylindrical portion 4 and an axis G of the protruding portion 3. In this way, at least the wheel W side of the welded portion 15 of the protruding portion 3 to which a stone chip or the like is most likely to fly can be surrounded by the protection wall 40.

Note that, in the present embodiment, the axis F of the outer shell 1 and the axis E of the cylindrical portion 4 are coaxial, and the protruding portion 3 protrudes perpendicularly to the axial direction of the outer shell 1. Therefore, in FIG. 3, the axis F of the outer shell 1 and the vertical line of the edge portion of the plane H appear to overlap when the shock absorber A is viewed from one side portion side of the cylindrical portion 4. However, for example, when the protruding portion 3 is disposed at a position rotated in a front-rear direction from the position illustrated in FIG. 3 in the circumferential direction of the outer shell 1, the axis F of the outer shell 1 and the vertical line of the edge portion of the plane H are shifted in the circumferential direction when the shock absorber A is viewed from one side portion side of the cylindrical portion 4.

As described above, even in a case where the axis F of the outer shell 1 and the vertical line of the edge portion of the plane H are shifted in the circumferential direction when the shock absorber A is viewed from one side portion side of the cylindrical portion 4, if the protection wall 40 rises at least from the entire edge of the insertion hole 8 located closer to the one attachment portion 5 than the axis F of the outer shell 1 as viewed from one side portion side of the cylindrical portion 4, or rises at least from the entire edge of the insertion hole 8 located closer to the one attachment portion 5 than the plane H passing through the axis E of the cylindrical portion 4 and the axis G of the protruding portion 3, the wheel W side as viewed from the protruding portion 3 side is always surrounded by the protection wall 40, so that the protection wall 40 can serve as a shield to protect the welded portion 15 of the protruding portion 3.

In addition, as described above, the bracket B of the present embodiment is formed by bending a base material which is one metal plate, and the protection wall 40 is also formed by bending the metal plate. Accordingly, since the protection wall 40 can also be formed simultaneously with the formation of the bracket B, the protection wall 40 can be easily formed, and the number of processing steps of the bracket B can also be reduced. However, the bracket B may be formed by forming the bracket B not including the protection wall 40 by bending and then welding the protection wall 40 to the edge of the insertion hole 8.

Further, the height of the protection wall 40 is not particularly limited, but in the present embodiment, the height of the protection wall 40 is set to be higher than the end of the welded portion 15 of the protruding portion 3 on the side opposite to the outer shell. Therefore, as compared with the case where the height of the protection wall 40 is lower than the end of the protruding portion 3 on the side opposite to the outer shell, the welded portion 15 of the protruding portion 3 can be more reliably protected from a stone chip or the like.

Next, a method of manufacturing the shock absorber A according to the present embodiment will be described. First, the outer shell 1 before formation of the protruding portion 3 is inserted into the cylindrical portion 4 of the bracket B. Then, while pressing the sleeve 30 against the side portion of the outer shell 1 exposed from the central position in the axial direction of the back opening 81, the sleeve 30 is welded to the edge portion of the attachment hole 1c formed in the side portion of the outer shell 1.

In this way, since the protruding portion 3 is welded to the outer shell 1 in a state of protruding from the back opening 81 having a longer axial length than the side opening 80, the distance between the edge of the insertion hole 8 and the protruding portion 3 can be increased. Thus, interference between a welding torch and the edge of the insertion hole 8 is easily avoided at the time of welding the protruding portion 3, so that the protruding portion 3 can be easily welded to the outer shell 1. In addition, since the protruding portion 3 can be welded to the outer shell 1 in a state where the attachment portions 5 and 6 face the opposite side of the protruding portion 3, the attachment portions 5 and 6 do not interfere with welding of the protruding portion 3, so that welding work of the protruding portion 3 can be easily performed.

Further, in the bracket B of the present embodiment, the protection wall 40 is provided only on the entire circumferential edge of the side opening 80, and is not provided on the edge of the back opening 81. Therefore, when the protruding portion 3 is welded to the outer shell 1 in a state of protruding from the back opening 81, the protection wall 40 does not hinder welding of the protruding portion 3.

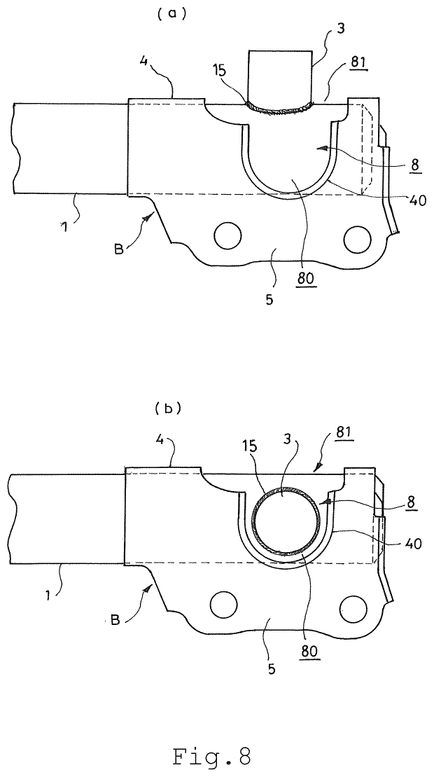

When the protruding portion 3 is welded to the outer shell 1 in this manner, as illustrated in FIG. 8 (a), the protruding portion 3 protrudes outward from the back portion of the bracket B through the back opening 81. Incidentally, the attachment hole 1c may be formed before welding of the sleeve 30 or after welding of the sleeve 30.

Next, as illustrated in FIG. 8 (b), the bracket B is shifted along the axial direction of the outer shell 1 so that the protruding portion 3 faces the side opening 80 in the circumferential direction, and then the bracket B is rotated along the circumferential direction of the outer shell 1 to move the protruding portion 3 to the side opening 80. Then, the cylindrical portion 4 is welded to the outer shell 1 in a state where the protruding portion 3 protrudes outward from the side opening 80.

Then, as illustrated in FIG. 1, in a state where the shock absorber A is attached to the vehicle, the front portion of the bracket B faces the wheel W side, and the protruding portion 3 protrudes forward or backward with respect to the vehicle. Thus, it is possible to prevent the protruding portion 3 from interfering with peripheral components in the vehicle.

Finally, a process of assembling the cylinder 11, the intermediate cylinder 14, the rod 2, the piston 20, the bottom member 13, and the like to the outer shell 1 is performed, and in this process, the damping force variable valve V is housed in the sleeve 30 and the cap 31 is placed thereon. However, the damping force variable valve V and the cap 31 can be assembled to the sleeve 30 at any time after the sleeve 30 is welded.

According to the above manufacturing method, in a state where the axial length of the side opening 80 is short and the protruding portion 3 is disposed in the side opening 80, even when the protruding portion 3 cannot be welded to the outer shell 1, the bracket B can be welded to the outer circumference of the outer shell 1 while the protruding portion 3 protrudes from the side opening 80.

As described above, according to the above manufacturing method, since the axial length of the side opening 80 can be shortened, the distance between the protruding portion 3 protruding from the side opening 80 and the protection wall 40 rising from the edge of the side opening 80 can be shortened. This enables the protection wall 40 to more reliably protect the welded portion 15 of the protruding portion 3 from a stone chip or the like.

Note that, the method of manufacturing the shock absorber A described above is an example, and is not limited to the above manufacturing method. For example, as long as the size of the side opening 80 is such that the welding torch does not interfere with the edge of the insertion hole 8 even when the protruding portion 3 is welded to the outer shell 1 while protruding outward, the protruding portion 3 may be welded to the outer shell 1 and the cylindrical portion 4 may be welded to the outer shell 1 in a state where the protruding portion 3 protrudes outward from the side opening 80. In this case, the insertion hole 8 may be formed only of the side opening 80.

As described above, the shock absorber A of the present embodiment includes: the shock absorber main body D that has the cylindrical outer shell 1 interposed between the vehicle body and the wheel W in the vehicle; the protruding portion 3 that is provided on the side portion of the outer shell 1 and protrudes radially outward; and the bracket B that is attached to the outer circumference of the outer shell 1. The bracket B has the cylindrical portion 4 that has the C-shaped cross section with the split 4a in the front portion while holding the outer circumference of the outer shell 1 and the pair of attachment portions 5 and 6 that protrudes radially outward from both ends in the circumferential direction of the cylindrical portion 4 and is capable of being attached to the knuckle N supporting the wheel W. The cylindrical portion 4 has the insertion hole 8 that is located in one side portion of the cylindrical portion 4 and through which the protruding portion 3 is inserted.

The cylindrical portion 4 has the protection wall 40 that rises from the entire edge of the insertion hole 8 located closer to the one attachment portion 5 than the axis F of the outer shell 1 when viewed at least from one side portion side of the cylindrical portion 4, or the protection wall 40 that rises from the entire edge of the insertion hole 8 located closer to the one attachment portion 5 than the plane H passing through at least the axis E of the cylindrical portion 4 and the axis G of the protruding portion 3.

According to this configuration, at least the wheel W side of the welded portion 15 of the protruding portion 3 to which a stone chip or the like is most likely to fly is surrounded by the protection wall 40 and protected from a stone chip or the like. In this manner, although the coating film of the welded portion 15 of the protruding portion 3 is easily peeled off because of poor coating film adhesion, because the welded portion 15 is protected from a stone chip or the like by the protection wall 40, the coating film of the welded portion of the protruding portion 3 becomes less likely to be peeled off. This makes the welded portion 15 of the protruding portion 3 less likely to rust. Further, since the protection wall 40 also functions as a reinforcing rib, the rigidity of the bracket B is also improved by the protection wall 40.

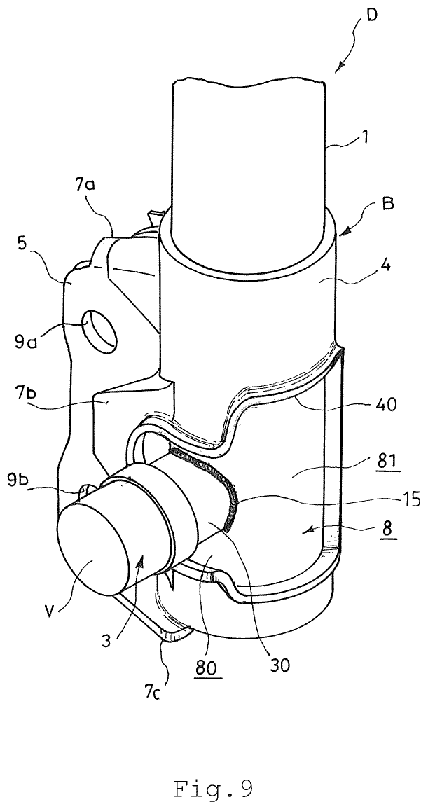

In addition, as illustrated in FIG. 9, the protection wall 40 may rise from the entire circumferential edge of the insertion hole 8. According to this configuration, since the entire circumference of the welded portion 15 of the protruding portion 3 is surrounded by the protection wall 40, it is also possible to protect the welded portion 15 of the protruding portion 3 from a stone chip or the like flying from a direction other than the wheel W side by hitting against the vehicle body or a peripheral component of the vehicle and bouncing back. Further, when the protection wall 40 rises from the entire circumferential edge of the insertion hole 8, the protection wall 40 also functioning as a reinforcing rib becomes longer, which further enhances the rigidity of the bracket B.

However, as in the present embodiment, the protection wall 40 may rise only from the entire circumferential edge of the side opening 80 in the insertion hole 8. This configuration is advantageous in that the protection wall 40 does not hinder the welding operation when the protruding portion 3 is welded to the outer shell 1 in a state of protruding outward from the back opening 81.

Meanwhile, in the shock absorber A according to the present embodiment, the bracket B is made of a metal plate, and the protection wall 40 is formed by bending the metal plate. According to this configuration, since the protection wall 40 can also be formed at the same time as the bracket B is formed by bending the metal plate, the protection wall 40 can be easily formed, and the number of processing steps of the bracket B can also be reduced.

However, the bracket B may be formed by forming the bracket B not including the protection wall 40 by bending and then welding the protection wall 40 to the edge of the insertion hole 8. In this way, since the protection wall 40 can be welded to the edge of the insertion hole 8 after the protruding portion 3 is welded to the outer shell 1, as illustrated in FIG. 9, even when the protection wall 40 rises from the entire circumferential edge of the insertion hole 8, there is no risk that the protection wall 40 hinders the welding operation when the protruding portion 3 is welded to the outer shell 1 in a state of protruding outward from the back opening 81.

Meanwhile, in the shock absorber A according to the present embodiment, the insertion hole 8 is formed from one side portion to the back portion of the cylindrical portion 4, and the axial length of the back opening 81 which is a portion of the insertion hole 8 located in the back portion of the cylindrical portion 4 is longer than the axial length of the side opening 80 which is a portion of the insertion hole 8 located in one side portion of the cylindrical portion 4.

This configuration enables the protruding portion 3 to be welded to the outer shell 1 in a state of protruding outward from the back opening 81, which is a portion having a long axial length in the insertion hole 8, before the bracket B is fixed to the outer circumference of the outer shell 1. In this manner, since the distance between the edge of the insertion hole 8 and the protruding portion 3 can be increased, it is easy to avoid interference between the welding torch and the edge of the insertion hole 8 at the time of welding the protruding portion 3, which enables the protruding portion 3 to be easily welded to the outer shell 1.

Further, according to the above configuration, the protruding portion 3 can be installed in the side opening 80 by disposing the protruding portion 3 in the back opening 81 and welding the protruding portion 3, then rotating the bracket B in the circumferential direction to arrange the protruding portion 3 in the side opening 80 which has a shorter axial length than the back opening 81, and then welding the bracket B to the outer shell 1. Thus, even when the axial length of the side opening 80 is so short that the protruding portion 3 cannot be welded to the outer shell 1 in a state where the protruding portion 3 is disposed in the side opening 80, the bracket B can be fixed to the outer circumference of the outer shell 1 in a state where the protruding portion 3 protrudes from the side opening 80.

As described above, according to the above configuration, since the axial length of the side opening 80 can be shortened, the distance between the protruding portion 3 protruding from the side opening 80 and the protection wall 40 rising from the edge of the side opening 80 can be shortened. This enables the protection wall 40 to more reliably protect the welded portion 15 of the protruding portion 3 from a stone chip or the like.

In addition, in the present embodiment, the protruding portion 3 is a case portion that houses the damping force variable valve V, but the protruding portion 3 may have a configuration other than the case portion. Further, the shock absorber A according to the present embodiment exerts a damping force by giving resistance to a flow of liquid, but may exert a damping force by other methods (such as an electromagnetic force, a frictional force, and the like), or may be an actuator that actively drives an object.

Although the preferred embodiment of the present invention has been described in detail above, modifications, variations, and alterations can be made without departing from the scope of the claims.

### REFERENCE SIGNS LIST

1 Outer shell
3 Protruding portion
4 Cylindrical portion
4a Split
5, 6 Attachment portion
8 Insertion hole
15 Welded portion
40 Protection wall
80 Side opening (portion located in one side portion of cylindrical portion of insertion hole)
81 Back opening (portion located in back portion of cylindrical portion of insertion hole)
B Bracket
D Shock absorber main body
E Axis of cylindrical portion
F Axis of outer shell
G Axis of protruding portion
H Plane
N Knuckle
W Wheel

1. A shock absorber comprising:
a shock absorber main body that has a cylindrical outer shell interposed between a vehicle body and a wheel in a vehicle;
a protruding portion that is provided on a side portion of the outer shell and protrudes radially outward; and
a bracket that is attached to an outer circumference of the outer shell, wherein
the bracket has a cylindrical portion that has a C-shaped cross section with a split in a front portion while holding the outer circumference of the outer shell and a pair of attachment portions that protrudes radially outward from both ends in a circumferential direction of the cylindrical portion and is capable of being attached to a knuckle supporting the wheel,
the cylindrical portion has an insertion hole that is located in one side portion of the cylindrical portion and through which the protruding portion is inserted, and
the cylindrical portion has a protection wall that rises from an entire edge of the insertion hole located closer to one of the attachment portions than an axis of the outer shell when viewed at least from the one side portion side of the cylindrical portion.

2. A shock absorber comprising:
a shock absorber main body that has a cylindrical outer shell interposed between a vehicle body and a wheel in a vehicle;
a protruding portion that is provided on a side portion of the outer shell and protrudes radially outward; and
a bracket that is attached to an outer circumference of the outer shell, wherein
the bracket has a cylindrical portion that has a C-shaped cross section with a split in a front portion while holding the outer circumference of the outer shell and a pair of attachment portions that protrudes radially outward from both ends in a circumferential direction of the cylindrical portion and is capable of being attached to a knuckle supporting the wheel,
the cylindrical portion has an insertion hole that is located in one side portion of the cylindrical portion and through which the protruding portion is inserted, and
the cylindrical portion has a protection wall that rises from an entire edge of the insertion hole located closer to one of the attachment portions than a plane passing through at least an axis of the cylindrical portion and an axis of the protruding portion.

3. The shock absorber according to claim 1, wherein
the bracket is made of a metal plate, and
the protection wall is formed by bending the metal plate.

4. The shock absorber according to claim 1, wherein
the insertion hole is formed from the one side portion to a back portion of the cylindrical portion, and
an axial length of a portion of the insertion hole located in the back portion of the cylindrical portion is longer than an axial length of a portion of the insertion hole located in the one side portion of the cylindrical portion.

5. The shock absorber according to claim 4, wherein
the protection wall rises only from an entire circumferential edge of a portion of the insertion hole located in the one side portion of the cylindrical portion.

6. The shock absorber according to claim 1, wherein
the protection wall rises from an entire circumferential edge of the insertion hole.
